(19) United States
(12) Patent Application Publication
(10) Pub. No.: US 2026/0219121 A1
(43) Pub. Date: Jul. 30, 2026

(54) SENSOR ATTACHMENT APPARATUS

(71) Applicant: Honda Motor Co., Ltd., Tokyo (JP)

(72) Inventor: Shota Maeda, Saitama (JP)

(21) Appl. No.: 19/455,249

(22) Filed: Jan. 21, 2026

(30) Foreign Application Priority Data
Jan. 24, 2025 (JP) 2025-010915

(51) Int. Cl. G01L 19/00; H01M 8/0438; H01M 8/10

(52) U.S. Cl. CPC G01L 19/0007; G01L 19/0069; H01M 8/04388; H01M 2008/1095

(57) ABSTRACT

A sensor attachment apparatus including a flow path forming member made of an insulating material and forming a gas flow path through which a reaction gas for a fuel cell flows, a spacer member made of a conductive material and mounted in a connection hole portion provided in the flow path forming member, a sensor attached to the spacer member, and a ground wire attached to the spacer member. The spacer member has a first end portion with a communication port facing an opening of the connection hole portion and a second end portion with a sensor attachment portion where the sensor is attached, extends in a predetermined direction intersecting a flow direction of the reaction gas from the first end portion to the second end portion, and is configured to form a closed space communicating with the gas flow path through the communication port.

### CROSS-REFERENCE TO RELATED APPLICATION

This application is based upon and claims the benefit of priority from Japanese Patent Application No. 2025-010915 filed on January 24, 2025, the content of which is incorporated herein by reference.

### BACKGROUND OF THE INVENTION

### Field of the Invention

This invention relates to a sensor attachment apparatus for attaching a sensor used in a fuel cell.

### Description of the Related Art

In recent years, technological developments have been made on a fuel cell that contribute to energy efficiency in order to ensure access to energy that is affordable, reliable, sustainable and advanced by more people. As a attachment structure for a sensor used in this type of fuel cell, a conventional structure is known in which the sensor is grounded via a ground wire to prevent output abnormalities due to static electricity. Such a device is described in, for example, Japanese Unexamined Patent Publication No. 2004-177221 (JP2004-177221A). In the structure described in JP2004-177221A, a sensor is attached to an insulating resin pipe, and a metal plate-like attachment member with a connected ground wire is provided connected to the metal sensor body.

However, in the structure of the device described in JP2004-177221A, the tip of the sensor is positioned along the inner wall surface of the insulating resin pipe, so water vapor and the like contained in the gas passing through the pipe may adhere to the tip of the sensor, potentially deteriorating the detection accuracy of the sensor.

### SUMMARY OF THE INVENTION

An aspect of the present invention is a sensor attachment apparatus including: a flow path forming member made of an insulating material and forming a gas flow path through which a reaction gas for a fuel cell flows; a spacer member made of a conductive material and mounted in an end portion of a connection hole portion provided in the flow path forming member; a sensor attached to the spacer member; and a ground wire attached to the spacer member. The spacer member has a first end portion with a communication port facing an opening of the connection hole portion and a second end portion with a sensor attachment portion where the sensor is attached, extends in a predetermined direction intersecting a flow direction of the reaction gas from the first end portion to the second end portion, and is configured to form a closed space communicating with the gas flow path through the communication port.

### BRIEF DESCRIPTION OF THE DRAWINGS

The objects, features, and advantages of the present invention will become clearer from the following description of embodiments in relation to the attached drawings, in which:

FIG. 1 is a diagram schematically illustrating a configuration a part of a fuel cell system to which a sensor attachment apparatus according to the embodiment of the present invention is applied;

FIG. 2 is a diagram schematically illustrating a configuration of an ejector included in the fuel cell system of FIG. 1;

FIG. 3 is a perspective view illustrating an external shape of a fuel gas supply and discharge part included in the fuel cell system of FIG. 1;

FIG. 4 is an exploded perspective view illustrating a configuration of a main part of a sensor attachment apparatus according to an embodiment of the present invention;

FIG. 5 is a perspective view illustrating an external shape of the sensor attachment apparatus according to the embodiment of the present invention;

FIG. 6 is a cross-sectional view of a main part of the sensor attachment apparatus taken along line VI-VI of FIG. 4;

FIG. 7 is a cross-sectional view of a main part of the sensor attachment apparatus taken along line VII-VII of FIG. 4: and

FIG. 8 is a cross-sectional view of a main part of the sensor attachment apparatus along a vertical plane passing through a predetermined axis of FIG. 4.

### DETAILED DESCRIPTION OF THE INVENTION

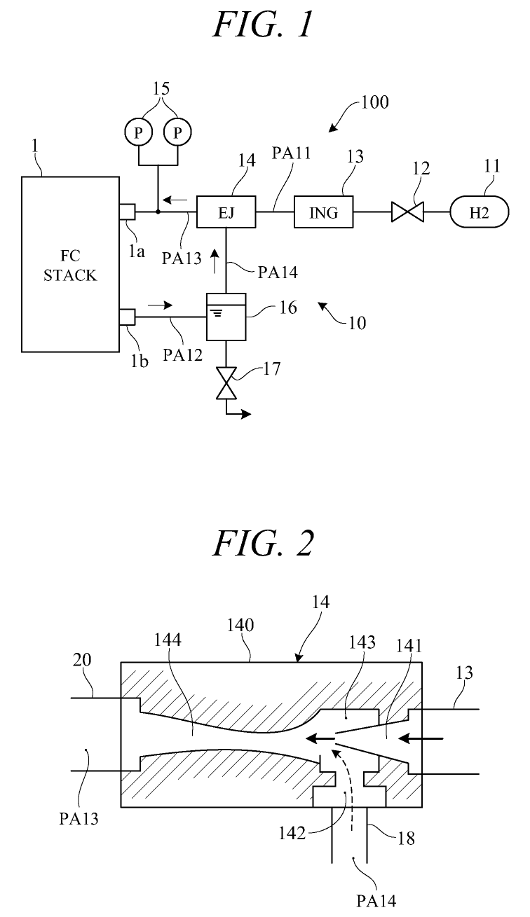

Hereinafter, an embodiment of the present invention will be described with reference to FIGS. 1 to 8. A sensor attachment apparatus according to the embodiment of the present invention is applied to a fuel cell. The fuel cell is configured to generate electric power by an electrochemical reaction between a hydrogen-containing fuel gas and an oxygen-containing oxidant gas. The fuel gas and the oxidant gas may be collectively referred to as reaction gas. The sensor attachment apparatus is used to attach a sensor that detects a physical quantity (temperature or pressure) of the reaction gas to the fuel cell. Hereinafter, as an example of the sensor attachment apparatus, a configuration of an attachment portion of a pressure sensor that detects the pressure of the fuel gas will be described.

FIG. 1 is a diagram schematically illustrating a configuration of a fuel cell system 100 to which the sensor attachment apparatus according to the embodiment of the present invention is applied. The fuel cell system 100 is mounted on a vehicle, for example, and generates electric power for driving the vehicle. FIG. 1 mainly illustrates a configuration related to a flow of the fuel gas. As illustrated in FIG. 1, the fuel cell system 100 includes a fuel cell stack (FC stack) 1 and a fuel gas supply and discharge part 10 that supplies the fuel gas to the fuel cell stack 1 and discharges the fuel gas from the fuel cell stack 1.

The fuel cell stack 1 is formed by stacking a plurality of power generation cells. Although not illustrated, the power generation cell includes a sheet-shaped or film-shaped membrane electrode structure formed by integrating a membrane electrode assembly and a film member provided with a substantially rectangular opening portion covered by the membrane electrode assembly, an anode separator disposed to face one surface of the membrane electrode structure, and a cathode separator disposed to face the other surface of the membrane electrode structure. The membrane electrode assembly includes an electrolyte membrane (for example, a solid polymer electrolyte membrane), an anode electrode formed on one surface of the electrolyte membrane, and a cathode electrode formed on the other surface of the electrolyte membrane.

The anode electrode includes an electrode catalyst layer that is formed on one surface of the electrolyte membrane and serves as a reaction site for an electrode reaction, and a gas diffusion layer that is provided in the electrode catalyst layer and diffuses and supplies the fuel gas. The cathode electrode includes an electrode catalyst layer that is formed on the other surface of the electrolyte membrane and serves as a reaction site for the electrode reaction, and a gas diffusion layer that is provided in the electrode catalyst layer and diffuses and supplies the oxidant gas. An anode flow path is formed between the anode electrode and one surface of the anode separator, and the fuel gas is supplied to the anode flow path. A cathode flow path is formed between the cathode electrode and one surface of the cathode separator, and the oxidant gas is supplied to the cathode flow path. A cooling flow path through which a cooling medium flows is formed between the other surface of the anode separator and the other surface of the cathode separator, the surfaces being adjacent to each other.

In the anode electrode, the fuel gas (hydrogen) supplied through the anode separator is ionized by an action of a catalyst, passes through the electrolyte membrane, and moves toward the cathode electrode. Electrons generated at this time pass through an external circuit and are extracted as electric energy. In the cathode electrode, the oxidant gas (oxygen) supplied through the cathode separator reacts with hydrogen ions guided from the anode electrode and the electrons moved from the anode electrode to generate water. The generated water provides an appropriate humidity to the electrolyte membrane, and excess water is discharged to the outside.

The fuel cell stack 1 is provided with a supply port 1a and a discharge port 1b for the fuel gas. The fuel gas supply and discharge part 10 includes a fuel gas supply flow path PA11 through which the fuel gas flows toward the supply port 1a, and a fuel gas discharge flow path PA12 through which the fuel gas (fuel exhaust gas) discharged from the discharge port 1b flows. The fuel gas flowing through the fuel gas supply flow path PA11 is supplied to the anode flow path in the fuel cell stack via the supply port 1a. The fuel gas flowing through the anode flow path is guided to the fuel gas discharge flow path PA12 via the discharge port 1b.

The fuel gas supply flow path PA11 is provided with a tank 11 that stores the high-pressure fuel gas, an on-off valve 12 that allows or blocks a flow of the fuel gas from the tank 11, an injector (INJ) 13 that injects the fuel gas supplied from the tank 11, and an ejector (EJ) 14 that supplies the fuel gas injected from the injector 13 to the fuel cell stack 1. In the fuel gas supply flow path PA11, a pair of pressure sensors 15 having the same configuration is connected to a connection flow path PA13 between the ejector 14 and the supply port 1a, and an inlet pressure of the fuel gas is detected by the pair of pressure sensors 15. One of the pair of pressure sensors 15 is a main sensor, and the other is a redundant sensor provided to increase reliability of a detection value of the main sensor.

A gas-liquid separator 16 is connected to the fuel gas discharge flow path PA12. In the gas-liquid separator 16, moisture contained in the fuel exhaust gas is separated from the fuel exhaust gas and stored. A drain valve 17 is connected to the gas-liquid separator 16. When the drain valve 17 is opened, water stored in the gas-liquid separator 16 is discharged to the outside. The gas-liquid separator 16 is connected to the ejector 14 via a circulation flow path PA14. The fuel exhaust gas separated in the gas-liquid separator 16 is returned to the ejector 14 via the circulation flow path PA14.

FIG. 2 is a diagram schematically illustrating a configuration of the ejector 14. As illustrated in FIG. 2, the ejector 14 includes a case 140 and a nozzle portion 141, a suction portion 142, a merging portion 143, and a diffuser portion 144, each of which is provided in the case 140. The injector 13, a circulation pipe 18 forming the circulation flow path PA14, and a connection pipe 20 forming the connection flow path PA13 are connected to the case 140.

The fuel gas injected from the injector 13 passes through the small-diameter nozzle portion 141 and then flows into the diffuser portion 144 via the merging portion 143, as indicated by a solid arrow in FIG. 2. At this time, the fuel gas (fuel exhaust gas) is sucked into the ejector 14 from the circulation flow path PA14 via the suction portion 142 as indicated by a dashed arrow in FIG. 2. The sucked fuel gas merges with the fuel gas that has passed through the nozzle portion 141 at the merging portion 143, is made into a uniform flow in the diffuser portion 144, and is then guided to the connection flow path PA13.

The injector 13 of FIG. 1 may be implemented by a single injector or a plurality of injectors. For example, a small injector having a small injection amount and a large injector having a large injection amount may be provided in parallel. In a case where the injector 13 is implemented by a plurality of injectors, the ejector 14 may be implemented by a plurality of ejectors. For example, a small ejector connected to the small injector and a large ejector connected to the large injector may be provided in parallel in the case 140 (FIG. 2).

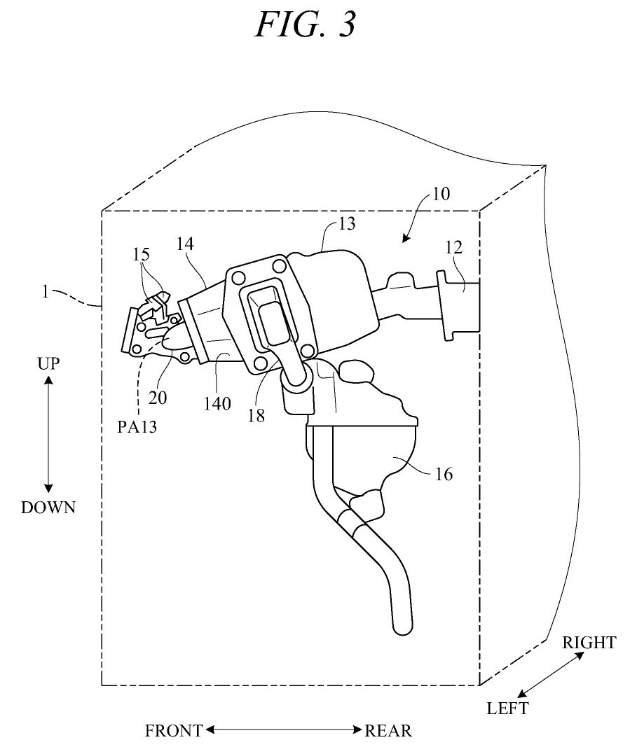

FIG. 3 is a perspective view schematically illustrating an external shape of the fuel gas supply and discharge part 10. For convenience, three axes orthogonal to each other as illustrated in the figure are defined as a front-rear direction, a left-right direction, and an up-down direction, and a configuration of each part will be described according to such definitions. The down direction in the up-down direction corresponds to a gravity direction. The front direction in the front-rear direction corresponds to, for example, a front side of the vehicle. In FIG. 3, an external shape of the fuel cell stack 1 is indicated by a line with alternating long and short dashes. As illustrated in FIG. 3, the fuel cell stack 1 has a substantially rectangular parallelepiped shape as a whole. The fuel gas supply and discharge part 10 is provided on a left side surface of the fuel cell stack 1.

More specifically, the ejector 14 is disposed on a front side of the injector 13, and one end portion (rear end portion) of the connection pipe 20 is connected to a front end portion of the ejector 14. The connection pipe 20 extends forward and then extends rightward to form the connection flow path PA13 having a substantially L shape in plan view, and the other end portion (right end portion) of the connection pipe 20 is connected to a left end surface of the fuel cell stack 1. The pair of pressure sensors 15 are disposed in front of and above the connection pipe 20. The gas-liquid separator 16 is disposed below the ejector 14. One end portion (lower end portion) of the circulation pipe 18 is connected to an upper end portion of the gas-liquid separator 16. The other end portion (upper end portion) of the circulation pipe 18 is bent to the right and connected to a left side surface of the case 140 of the ejector 14.

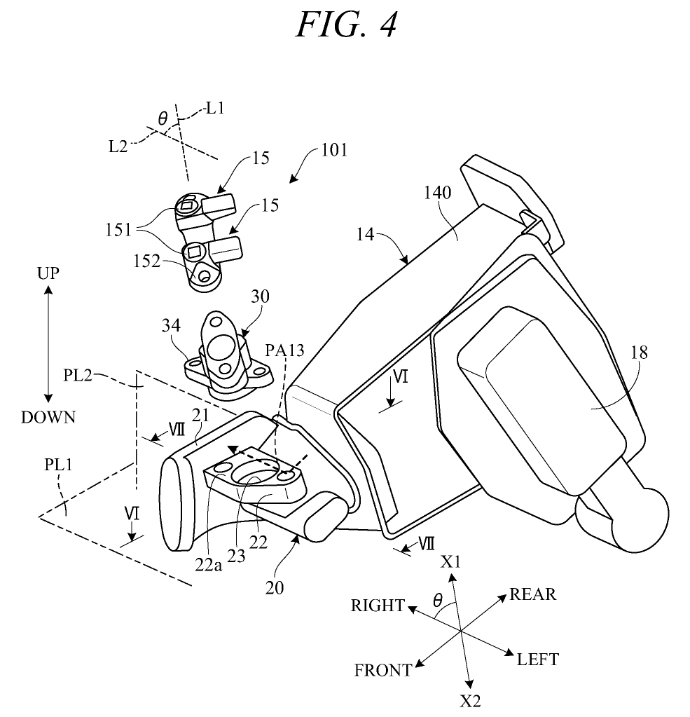

FIG. 4 is an exploded perspective view (a view viewed from above and obliquely forward) illustrating a configuration of a main part of a sensor attachment apparatus 101 according to the present embodiment. FIG. 4 illustrates a state in which the connection pipe 20 and the circulation pipe 18 are integrally coupled to the ejector 14. Further, FIG. 4 illustrates the pressure sensors 15 in a state of being separated from the connection pipe 20.

In the connection pipe 20, the substantially L-shaped connection flow path PA13 bent from the front to the right at an angle of approximately 90 degrees is formed as indicated by a dotted line in FIG. 4. A substantially rectangular flange portion 21 extending in the front-rear direction and the up-down direction is provided at the right end portion of the connection pipe 20. The flange portion 21 is fixed to the left side surface of the fuel cell stack 1 (FIG. 3).

A flange portion 22 is provided on a front side of the connection flow path PA13 at an upper portion of the connection pipe 20. A flange surface 22a extending in a substantially horizontal direction is provided on an upper surface of the flange portion 22. A substantially circular opening 23 is provided at a central portion of the flange surface 22a. A spacer member 30 is attached to the flange portion 22, and the pair of pressure sensors 15 are attached to the spacer member 30. The connection pipe 20 is made of a resin material (insulating material) having an electrical insulation property. The spacer member 30 is made of a conductive metal (conductive material).

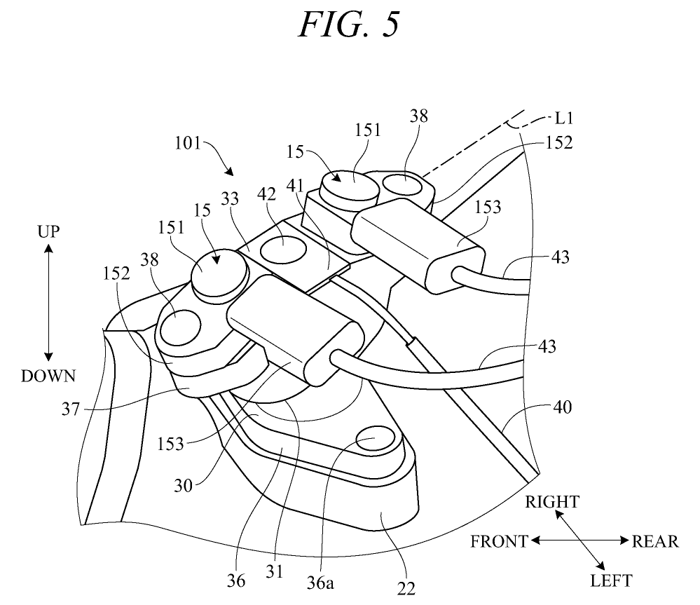

FIG. 4 illustrates a virtual horizontal plane PL1 extending in the front-rear direction and the left-right direction along the connection flow path PA13, and a virtual vertical plane PL2 extending in the left-right direction along the connection flow path PA13 and extending in the up-down direction. Further, FIG. 4 illustrates a pair of reference lines L1 and L2 extending on the same horizontal plane above the pressure sensors 15. FIG. 5 is a perspective view illustrating an external shape of the sensor attachment apparatus 101 in a state in which the pressure sensors 15 are attached. As illustrated in FIG. 5, the reference line L1 is a straight line passing through the centers of the pair of pressure sensors 15, and the pair of pressure sensors 15 are disposed on the reference line L1. As illustrated in FIG. 4, the reference line L2 extends in the left-right direction, and the reference line L1 intersects the reference line L2 at a predetermined angle θ of 45 degrees or less. A direction in which the reference line L1 extends is defined as an X1-X2 direction. The reference line L1 passes through the center of the opening 23 of the flange portion 22 of the connection pipe 20.

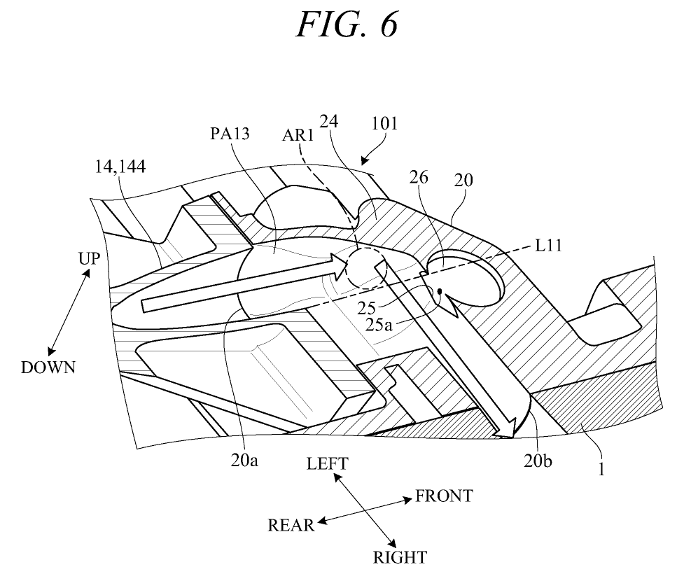

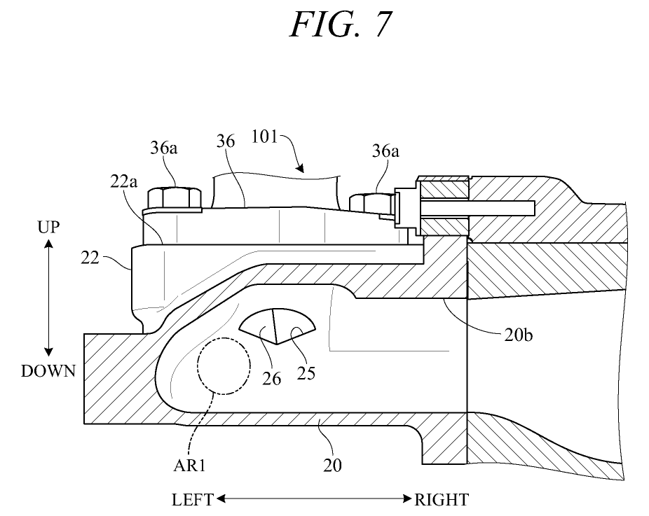

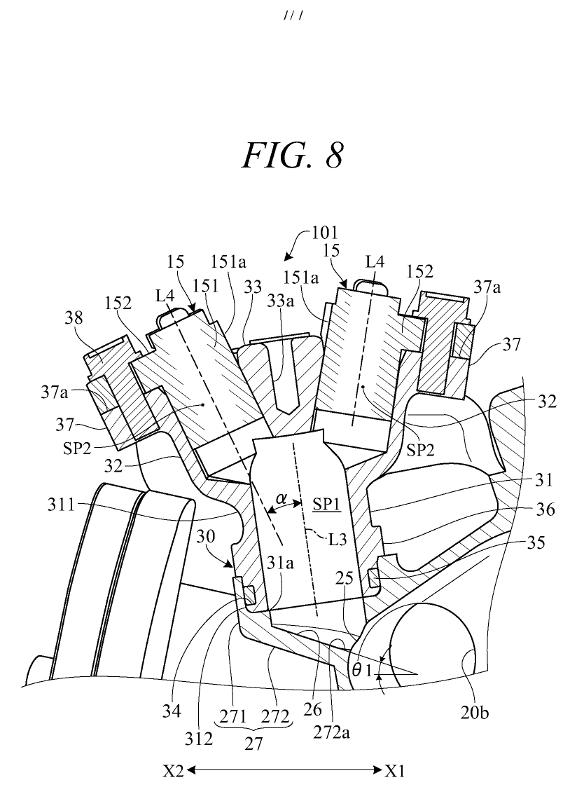

FIG. 6 is a cross-sectional view of a main part of the sensor attachment apparatus 101 along the horizontal plane PL1 (a cross-sectional view taken along line VI-VI in FIG. 4), and FIG. 7 is a cross-sectional view of a main part of the sensor attachment apparatus 101 along the vertical plane PL2 (a cross-sectional view taken along line VII-VII in FIG. 4). FIG. 8 is a cross-sectional view of a main part of the sensor attachment apparatus 101 along a vertical plane passing through the reference line L1 (FIG. 5). FIGS. 6 to 8 are cross-sectional views illustrating a state in which the pressure sensors 15 are attached to the connection pipe 20 via the spacer member 30, and the connection pipe 20 is attached to the fuel cell stack 1. That is, as illustrated in FIG. 3, FIGS. 6 to 8 illustrate cross-sectional views of the main parts of the sensor attachment apparatus 101 in a state in which the fuel gas supply and discharge part 10 is attached to the fuel cell stack 1.

As illustrated in FIG. 6, the connection pipe 20 is provided with a rear end opening 20a opened to a rear end surface and a right end opening 20b opened to a right end surface, and the connection flow path PA13 is formed from the rear end opening 20a to the right end opening 20b. A curved portion 24 having an arc-shaped inner wall surface is provided at a left-front corner of the connection pipe 20, and the curved portion 24 changes a direction of the flow of the reaction gas that has passed through the ejector 14 (diffuser portion 144) from a forward direction to a rightward direction as indicated by an arrow. Specifically, the reaction gas collides with a gas collision region AR1 (a line with alternating long and two short dashes) on the inner wall surface of the curved portion 24 in front of the rear end opening 20a. As a result, a flow velocity decreases and the direction of the flow changes to the rightward direction.

The curved portion 24 will be further described. The curved portion 24 has a portion where an inner wall surface of the connection pipe 20 is not straight or flat but is smoothly curved. That is, the inner wall surface of the connection pipe 20 forming the connection flow path PA13 is formed in a concave curved shape by the curved portion 24. As the curved portion 24 is provided, a gas flow loss is suppressed. As illustrated in FIG. 6, a center point 25a of an opening 25 is provided at a position downstream (right side) of a straight line L11 in the direction of the flow of the reaction gas, the straight line L11 being a straight line along the inner wall surface forming an outlet flow path of the ejector 14 on a side of the direction (rightward) of the flow of the reaction gas flowing out of the ejector 14.

As illustrated in FIGS. 6 and 7, at a front end portion of the connection pipe 20, the opening 25 is provided along the inner wall surface of the connection pipe 20 above an intermediate position in the up-down direction on the connection flow path PA13, and a hole portion 26 is provided so as to be directed upward while communicating with the opening 25. More specifically, the substantially circular or substantially elliptical opening 25 is provided at an upper-front portion of the inner wall surface (a portion of the inner wall surface adjacent to the flange portion 22 in FIG. 4) of the connection pipe 20. The opening 25 is provided on a right side of the gas collision region AR1, that is, at a position downstream of the gas collision region AR1 in the direction of the flow of the reaction gas while being shifted from the gas collision region AR1. A shape of the opening 25 can be appropriately set according to a shape of the hole portion 26.

As illustrated in FIGS. 7 and 8, the hole portion 26 extends forward (or in the X2 direction) and upward from the opening 25. That is, as illustrated in FIG. 8, in the connection pipe 20, a wall portion 27 protrudes from the opening 25, and the hole portion 26 is formed by the wall portion 27. The wall portion 27 has a support portion 271 that supports the spacer member 30 and an inclined portion 272 positioned on a lower side of the support portion 271. The support portion 271 is provided at an upper end portion of the wall portion 27 and has a substantially cylindrical shape centered on an axis L3. A direction in which the axis L3 extends is a direction in which the hole portion 26 and the spacer member 30 extend, and in FIG. 8, the axis L3 extends in the substantially up-down direction. The substantially up-down direction includes an up-down direction along a vertical line and a direction whose angle from the vertical line is a predetermined angle or less (for example, 30 degrees or less or 45 degrees or less), that is, a substantially vertical direction.

The inclined portion 272 is mainly formed by a lower portion of the wall portion 27, and extends from a lower end portion side of the opening 25 to the support portion 271. The inclined portion 272 is inclined with an upward gradient toward the front, whereby an inner area of the hole portion 26 (an area of a plane orthogonal to the axis L3) gradually increases upward. An upper surface (inclined surface 272a) of the inclined portion 272 is inclined at a predetermined angle θ1 with respect to a horizontal line. An angle formed by the support portion 271 connected to an upper end portion of the inclined portion 272 with respect to the horizontal line is larger than the predetermined angle θ1, and the support portion 271 is erected from the upper end portion of the inclined portion 272.

The spacer member 30 includes a substantially cylindrical case portion 31 having an upper end portion 311 and a lower end portion 312, and a pair of holder portions 32 protruding from the upper end portion 311 of the case portion 31 in the X1 direction and the X2 direction. The case portion 31 has an opening 31a provided on an end surface (lower end surface) of the lower end portion 312. A columnar closed space SP1 centered on the axis L3 and having a lower end opened is formed inside the case portion 31. The pair of holder portions 32 are symmetrical with respect to the axis L3. A substantially columnar accommodation space SP2 centered on an axis L4 and having an upper end opened is formed by the holder portions 32. The axis L4 intersects the axis L3 at a predetermined angle α. As the predetermined angle α increases, a size of an upper surface region of a top portion 33 at the center of the spacer member 30 above the axis CL3 can increase. The predetermined angle α is set in a range of, for example, 0° < α < 45° so as to form a predetermined upper surface region of the top portion 33.

A lower end portion of the accommodation space SP2 intersects a corner portion of an upper end of the closed space SP1, and the accommodation space SP2 and the closed space SP1 communicate with each other. A lower end portion of the holder portion 32 on an X2 direction side and a lower end portion of the holder portion 32 on an X1 direction side are bent toward the axis L3 so as to be substantially orthogonal to the axis L3. As a result, a length of the holder portion 32 in the up-down direction can be reduced, and a length of the case portion 31 can be increased in the up-down direction accordingly. A recess 34 is provided on an outer peripheral surface of the case portion 31 in the vicinity of the lower end portion 312, and a sealing member 35 such as an O-ring is fitted into the recess 34. A flange portion 36 is provided above the recess 34. As illustrated in FIGS. 5 and 7, the flange portion 36 extends in the left-right direction and is fastened to the flange surface 22a of the connection pipe 20 via a bolt 36a.

As illustrated in FIG. 8, a pair of flange portions 37 are provided at an upper end portion of the spacer member 30 (holder portion 32) with the axis L3 interposed therebetween. An upper surface 37a of the flange portion 37 on an X2 side is inclined with a gentle downward gradient in the X2 direction. An upper surface 37a of the flange portion 37 on an X1 side is inclined with a gentle downward gradient in the X1 direction. Therefore, the upper surface 37a of the flange portion 37 on the X2 side and the upper surface 37a of the flange portion 37 on the X1 side are not on the same plane, and a pair of extension surfaces obtained by extending the upper surfaces 37a and 37a intersect each other on the axis L3.

As illustrated in FIGS. 5 and 8, the pair of pressure sensors 15 are attached to the pair of flange portions 37. The pressure sensor 15 includes a sensor body 151 and a flange portion 152 protruding outward (toward a side opposite to the axis L3) from the sensor body 151. A through hole is formed in the flange portion 152, and a bolt 38 inserted through the through hole is screwed into a screw hole provided in the flange portion 37 of the spacer member 30, whereby the pressure sensor 15 is fastened to the spacer member 30.

As illustrated in FIG. 8, the sensor body 151 has a substantially columnar body portion 151a made of metal, and the body portion 151a is fitted into the accommodation space SP2. A detection unit that detects the pressure of the reaction gas is provided at a distal end portion (lower end portion) of the body portion 151a. In a state in which the body portion 151a is fitted, a lower end portion of the sensor body 151 is positioned above an intersection between the closed space SP1 and the accommodation space SP2. A bottomed screw hole 33a is provided along the axis L3 on an upper surface of the top portion 33.

As illustrated in FIG. 5, a bolt 42 is screwed into the screw hole 33a with a distal end portion 41 of a ground wire 40 interposed therebetween, whereby the ground wire 40 is fixed between the pair of pressure sensors 15. Although not illustrated, an end portion of the ground wire 40 is connected to a vehicle body, and the spacer member 30 is grounded via the ground wire 40. As a result, static electricity at a distal end portion of the pressure sensor 15 can be released to the ground via the spacer member 30 and the ground wire 40. As a result, it is possible to prevent the pressure sensor 15 from being charged with the static electricity, and it is possible to prevent output abnormality of the pressure sensor 15. An upper end portion of the pressure sensor 15 is provided with a connection portion 153 facing rearward or leftward as illustrated in FIG. 5, and an electric line 43 such as a power line or a signal line is connected to the connection portion 153.

A main operation of the sensor attachment apparatus 101 according to the present embodiment will be described. During operation of the fuel cell, the fuel gas is supplied to the fuel cell stack 1 via the fuel gas supply and discharge part 10. The fuel gas flows through the substantially L-shaped connection flow path PA13 inside the connection pipe 20 along an arrow in FIG. 6. The opening 25 is provided on the inner wall of the connection pipe 20 along the connection flow path PA13, and the spacer member 30 made of metal is attached to the flange portion 22 formed on the end surface of the hole portion 26 on a back side of the opening 25. The substantially columnar closed space SP1 is formed in the spacer member 30, and the pressure sensors 15 are accommodated in the accommodation spaces SP2 above the closed space SP1. Therefore, the detection unit positioned at the distal end of the pressure sensor 15 is not exposed to a gas flow path (connection flow path PA13). As a result, it is possible to prevent the fuel gas in the connection flow path containing water vapor from directly contacting the detection unit of the pressure sensor 15, so that the pressure of the fuel gas can be accurately detected by the pressure sensor 15.

In particular, the fuel gas flowing into the connection pipe 20 from the diffuser portion 144 collides with the gas collision region AR1 (FIG. 6), and the opening 25 of the hole portion 26 is provided at a position downstream of the gas collision region AR1. Therefore, the fuel gas can be prevented from vigorously flowing into the closed space SP1, and the pressure sensor 15 detects the pressure of the fuel gas with a decreased flow velocity. Accordingly, accuracy in detection of the pressure of the fuel gas by the pressure sensor 15 can be enhanced. Since the closed space SP1 has a substantially columnar shape, a favorable swirling flow of the fuel gas can be generated inside the spacer member 30. That is, it is possible to generate a swirling flow that flows in through the opening 31a and flows out through the opening 31a, more specifically, a swirling flow that is drawn into the gas flow in the connection flow path PA13. As a result, it is possible to satisfactorily detect the pressure of the fuel gas without generating an irregular flow in the closed space SP1.

In the present embodiment, the pair of pressure sensors 15 are provided symmetrically with respect to the axis L3. The pair of pressure sensors 15 are respectively disposed in the pair of accommodation spaces SP2 above the closed space SP1. In the closed space SP1, the favorable swirling flow of the fuel gas is generated as described above, and thus, the fuel gas having the same flow velocity flows into the pair of accommodation spaces SP2. As a result, the pair of pressure sensors 15 can detect the pressure of the fuel gas in the same state, so that it is possible to suppress the occurrence of a difference between the detection values of the pair of pressure sensors 15.

The ground wire 40 is connected to the top portion 33 of the spacer member 30 at a position on the axis L3. As a result, the static electricity charged at the distal end portion of the pressure sensor 15 can be released to the ground via the ground wire 40, and the output abnormality of the pressure sensor 15 can be prevented. In addition, since the ground wire 40 is disposed at the intermediate position between the pair of pressure sensors 15, the pair of pressure sensors 15 can obtain the same grounding effect with the single ground wire 40.

The hole portion 26 of the connection pipe 20 is formed by the wall portion 27. The wall portion 27 has the inclined surface 272a inclined with the upward gradient of the predetermined angle θ1 from the opening 25, and the spacer member 30 is disposed above the inclined surface 272a. As a result, when the vehicle stops in an inclined posture, for example, it is possible to prevent the generated water and condensed water in the connection flow path PA13 from entering the closed space SP1 and wetting the pressure sensor 15, so that it is possible to enhance the detection accuracy of the pressure sensor 15. In addition, the wall portion 27 has the support portion 271 that is continuous with the inclined portion 272 and is erected upward at an obtuse angle with respect to the inclined portion 272. As a result, a swirling flow of the fuel gas is easily generated in the closed space SP1, and the pressure of the fuel gas can be satisfactorily detected by the pressure sensor 15.

According to the present embodiment, the following operations and effects are achievable.

(1) The sensor attachment apparatus 101 includes: the connection pipe 20 that forms the fuel gas supply flow path PA11 (connection flow path PA13) through which the reaction gas (fuel gas) for the fuel cell flows and is made of an insulating material; the spacer member 30 that is mounted on the flange portion 22 at the end portion of the hole portion 26 provided in the connection pipe 20 and is made of a conductive material; the pressure sensor 15 that is attached to the spacer member 30; and the ground wire 40 that is attached to the spacer member 30 (FIGS. 5 to 8). The spacer member 30 includes the case portion 31, and the case portion 31 has the lower end portion 312 provided with the opening 31a facing the hole portion 26 and the upper end portion 311 provided with the holder portion 32 to which the pressure sensor 15 is attached, extends substantially upward from the lower end portion 312 to the upper end portion 311, and forms the closed space SP1 communicating with the connection flow path PA13 via the opening 31a (FIG. 8).

As a result, the pressure sensor 15 is disposed away from the connection flow path PA13 via the closed space SP1. Therefore, since the detection unit positioned at the distal end of the pressure sensor 15 is not exposed to the gas flow path (connection flow path PA13), it is possible to prevent the fuel gas containing water vapor from directly contacting the detection unit of the pressure sensor 15. As a result, the pressure sensor 15 can accurately detect the pressure of the fuel gas.

(2) The hole portion 26 of the connection pipe 20 is formed by the wall portion 27 (FIG. 8). The wall portion 27 extends from the opening 25 facing the connection flow path PA13 to the opening 31a of the spacer member 30 (FIG. 8). The wall portion 27 has the inclined surface 272a inclined with an upward gradient from the opening 25 toward the opening 31a (FIG. 8). As a result, when the vehicle stops in an inclined posture, for example, it is possible to prevent the generated water and condensed water in the connection flow path PA13 from entering the closed space SP1 and wetting the pressure sensor 15, so that it is possible to enhance the detection accuracy of the pressure sensor 15.

(3) The hole portion 26 of the connection pipe 20 is formed by the wall portion 27 (FIG. 8). The wall portion 27 extends from the opening 25 facing the connection flow path PA13 to the opening 31a of the spacer member 30 (FIG. 8). The wall portion 27 has the inclined portion 272 extending from the opening 25, and the support portion 271 that is continuous with the inclined portion 272, rises more steeply than the inclined portion 272, and extends to the opening 31a (FIG. 8). The inclined portion 272 and the support portion 271 intersect each other at an obtuse angle (FIG. 8). As a result, a swirling flow of the fuel gas is easily generated in the closed space SP1, and the pressure of the fuel gas can be satisfactorily detected by the pressure sensor 15.

(4) The connection pipe 20 has the curved portion 24 where the connection flow path PA13 is curved (FIG. 6). The opening 25 of the hole portion 26 facing the connection flow path PA13 is provided at a position downstream of the curved portion 24 in the direction of the flow of the fuel gas (FIG. 6). As a result, the pressure sensor 15 detects the pressure of the fuel gas that collides with the inner wall surface of the connection pipe 20 and thus has a decreased flow velocity, so that the accuracy in detection of the pressure of the fuel gas by the pressure sensor 15 can be enhanced.

(5) The pair of holder portions 32 forming the accommodation spaces SP2 of the pressure sensors 15 are provided at an upper portion of the spacer member 30 (FIG. 8). The ground wire 40 is disposed between the pair of holder portions 32 (FIGS. 5 and 8). As a result, the pair of pressure sensors 15 can obtain the same grounding effect with the single ground wire 40.

(6) The sensor attachment apparatus 101 is applied to the pressure sensor 15 that detects the pressure of the fuel gas. As a result, it is possible to satisfactorily detect the pressure of the fuel gas containing water vapor.

(7) The spacer member 30 forms the closed space SP1 having a substantially columnar shape (FIG. 8). As a result, a swirl flow can be favorably generated inside the spacer member 30, and the accuracy in detection of the pressure by the pressure sensor 15 can be enhanced.

The above embodiments can be modified to various forms. Hereinafter, several modified examples will be described. In the above embodiment, the sensor attachment apparatus 101 is applied to the connection pipe 20 between the ejector 14 and the fuel cell stack 1, but a sensor attachment apparatus of the present invention can also be applied to another flow path forming member made of an insulating material that forms a gas flow path through which a reaction gas for a fuel cell flows. That is, the present invention can also be applied to the flow path forming member that forms the flow path through which the fuel gas flows. The present invention can also be applied to the flow path forming member that forms the flow path for the oxidant gas.

In the above embodiment, the pressure sensor 15 is attached to the spacer member 30, but another sensor (e.g., a temperature sensor) may also be attached to the spacer member, and the sensor to which the sensor attachment apparatus is applied are not limited to those described above. In the above embodiment, the ground wire 40 is connected to the top portion 33 of the spacer member 30 between the pair of holder portions 32 (sensor attachment portions), but if it is attached to a spacer member made of conductive material, the attachment position of the ground wire is not limited to that described above. In the above embodiment, the pair of pressure sensors 15 are attached via the pair of holder portions 32 to the spacer member 30, but the number of sensors attached to the spacer member may be one or more than three. Therefore, the number of holder portions 32 is not limited to that described above.

In the above embodiment, the hole portion 26 (a connection hole portion) of the connection pipe 20 is formed by the wall portion 27 extending from the opening 25 facing the connection flow path PA13 to the opening 31a (a communication port) of the spacer member 30. More specifically, the wall portion 27 is provided with the inclined surface 272a that inclines upward from the opening 25 toward the opening 31a. Additionally, the wall portion 27 includes the inclined portion 272 (a first wall portion) extending from the opening 25, and the support portion 271 (a second wall portion) that rises more steeply than the inclined portion 272 and extends toward the opening 31a, with the inclined portion 272 and the support portion 271 intersecting at an obtuse angle. However, if it is provided from an opening facing a gas flow path to a communication port (lower end opening) of the spacer member, the configuration of a wall portion of the flow path forming member may be any configuration.

In the above embodiment, the case portion 31 of the spacer member 30 is configured to form a substantially columnar closed space SP1, but the shape of a closed space formed by the spacer member is not limited to that described above. In the above embodiment, the spacer member 30 is configured to have the substantially cylindrical case portion 31 and the pair of holder portions 32, but the configuration of a mounted portion such as the flange portion 22 at the end of the hole portion 26 (a connection hole portion) provided in the connection pipe 20 (a flow path forming member), that is, the configuration of a spacer member made of conductive material and mounted in the connection hole portion, is not limited to that described above. In other words, as long as the spacer member is configured to have a first end portion (the lower end portion 312) where a communication port (e.g., opening 31a) arranged in the connection hole portion is provided, and a second end portion (the upper end portion 311) where a sensor attachment portion (e.g., the holder portion 32) with a sensor (e.g., the pressure sensor 15) is provided, extending in a predetermined direction intersecting the flow direction of the reaction gas from the first end portion to the second end portion, forming a closed space communicating with the gas flow path, the configuration of the spacer member may be any configuration. Therefore, the predetermined direction intersecting the flow direction of the reaction gas is not limited to upward or approximately upward. In this case, the intersection means both that two or more linear objects intersect at a point, and that although they do not intersect at a point, the portions where two or more linear objects are closest to each other are included within a predetermined area, meaning they are in a skew relationship.

In the above embodiment, an example of applying the fuel cell system 100 to a vehicle is described, but the fuel cell system to which the sensor attachment apparatus of the present invention is applied can also be applied to mobile bodies other than vehicles, such as aircraft and ships, as well as robots and various industrial machines.

The above embodiment can be combined as desired with one or more of the above modifications. The modifications can also be combined with one another.

According to the present invention, it is possible to enhance a detection accuracy of a sensor used in a fuel cell.

Above, while the present invention has been described with reference to the preferred embodiments thereof, it will be understood, by those skilled in the art, that various changes and modifications may be made thereto without departing from the scope of the appended claims.

What is claimed is:

1. A sensor attachment apparatus comprising:
a flow path forming member made of an insulating material and forming a gas flow path through which a reaction gas for a fuel cell flows;
a spacer member made of a conductive material and mounted in an end portion of a connection hole portion provided in the flow path forming member;
a sensor attached to the spacer member; and
a ground wire attached to the spacer member, wherein
the spacer member has a first end portion with a communication port facing an opening of the connection hole portion and a second end portion with a sensor attachment portion where the sensor is attached, extends in a predetermined direction intersecting a flow direction of the reaction gas from the first end portion to the second end portion, and is configured to form a closed space communicating with the gas flow path through the communication port.

2. The sensor attachment apparatus according to claim 1, wherein
the flow path forming member has a wall portion forming the connection hole portion and extending from the opening facing the gas flow path to the communication port of the spacer member, and
the wall portion has an inclined surface inclined with an upward gradient from the opening toward the communication port.

3. The sensor attachment apparatus according to claim 1, wherein
the flow path forming member has a wall portion forming the connection hole portion and extending from the opening facing the gas flow path to the communication port of the spacer member,
the wall portion has a first wall portion extending from the opening, and a second wall portion connected to the first wall portion and extending toward the communication port,
the second wall portion is inclined upward more steeply than the first wall portion, and
the first wall portion and the second wall portion intersect at an obtuse angle.

4. The sensor attachment apparatus according to claim 1, wherein
the flow path forming member has a curved portion where the gas flow path is curved, and
the opening of the connection hole portion facing the gas flow path is provided downstream of the curved portion in the flow direction of the reaction gas.

5. The sensor attachment apparatus according to claim 1, wherein
the spacer member has a pair of sensor attachment portions provided at the second end portion, and
the ground wire is disposed between the pair of sensor attachment portions.

6. The sensor attachment apparatus according to claim 1, wherein
the sensor is a pressure sensor that detects a pressure of the reaction gas.

7. The sensor attachment apparatus according to claim 1, wherein
the spacer member is configured to form the closed space having a substantially columnar shape.

8. The sensor attachment apparatus according to claim 1, wherein
the spacer member has a flange portion fastened to the end portion of the connection hole portion via a bolt, at the first end portion.

9. The sensor attachment apparatus according to claim 1, wherein
the spacer member has a flange portion to which the sensor is attached via a bolt, at an end portion of the sensor attachment portion.

10. The sensor attachment apparatus according to claim 1, wherein
the spacer member is configured to form the closed space having a substantially columnar shape centered on a first axis, and has a pair of the sensor attachment portions provided at the second end portion, and
the pair of the sensor attachment portions are configured to form a pair of accommodation spaces, each of the pair of accommodation spaces having a substantially columnar shape centered on a respective second axis intersecting the first axis at a predetermined angle.
